(19) United States
(12) Patent Application Publication
(10) Pub. No.: US 2006/0157511 A1
(43) Pub. Date: Jul. 20, 2006

(54) Device for packaging and dispensing a liquid or semi-liquid product

(75) Inventors: Paulo Do Rosario, Louviers (FR); Daniel De Rosa, Louviers (FR)

Correspondence Address: YOUNG & THOMPSON, 745 SOUTH 23RD STREET, 2ND FLOOR, ARLINGTON, VA, 22202, US

(73) Assignee: INNOVATION PACKAGING, ACQUIGNY (FR)

(21) Appl. No.: 10/534,039

(22) PCT Filed: Nov. 5, 2003
(86) PCT No.: PCT/FR03/03306

§ 371 Date: May 6, 2005

(30) Foreign Application Priority Data
Nov. 6, 2002 (FR) 02 13879

(51) Int. Cl. B67D 5/06

(52) U.S. Cl. 222/183; 222/402.1; 222/383.1

(57) ABSTRACT

A packaging and dispensing device (1) includes a reservoir (2), an ejecting assembly (5) supported on one wall (4) of the reservoir and provided with an actuating member (7, 9, 19) exiting from the reservoir, said actuating member being adapted to be moved along a so-called vertical direction, linking elements (32, 31, 30) including one first end (23) linked to the actuating member and a second end (30) linked to an outlet member (24, 29) and which are deformable between the first and second ends to be able to drive a certain amount of product up to the outlet member. From at least one of the ends, the linking elements include at least one end portion (23, 30) oriented so as to be spaced apart from a zone (B) in the form of a vertical planar strip containing a geometrical line directly connecting the actuating member and the outlet member.

The present invention relates to a packaging and dispensing device for a liquid or semi-liquid product, of the type comprising a reservoir, an ejection assembly connected to a wall of said reservoir and equipped with an actuating member protruding from said reservoir, said actuating member being able to be moved in an actuating direction, known as the vertical direction, to eject a quantity of said product from said reservoir through a passage formed in said actuating member, connecting means which have a first end connected to said actuating member and a second end connected to an outlet member and which are deformable over at least part of their length between said first and second ends so as to be able to conduct said quantity of product as far as said outlet member without transmitting substantial force to said outlet member, said outlet member being connected fixedly to said reservoir and comprising an outlet opening so as to be able to dispense said quantity of product.

In known devices of this type, the ejection assembly is typically a manually operated pump, in the case of a non-pressurized reservoir, or valve in the case of a pressurized reservoir. The actuating member typically adopts the form of a hollow pump rod or of a valve surmounted by a push-button.

These devices make it possible accurately to dispense the product concerned in the desired direction and at the desired point by virtue of the fixedness of the outlet member with respect to the reservoir and by virtue of the absence of the transmission of substantial force to the outlet member, that is to say of any force likely to cause it move perceptibly. Devices of this type are known for dispensing products or cosmetic, pharmaceutical or other use, for example from documents U.S. Pat. No. 3,640,274 A, FR 2 767 799 A and U.S. Pat. No. 3,189,232 A.

A need has been felt for this type of device to provide sufficient length of the connecting means so as to reduce their stiffness and so that the deformable part or parts do not experience excessively localized deformations resulting in fatigue and premature ageing of the material. Various solutions have been proposed for this purpose.

FR 2 767 799 A envisages offsetting the pump from the axis of revolution of the reservoir so as to move it further away from the spray nozzle and thus correspondingly lengthen the flexible coupling connecting them. This solution is, however, reserved for devices that are large enough in the pump-nozzle direction, that is to say incompatible with devices of a particular shape.

U.S. Pat. No. 3,640,274 A envisages lengthening the flexible pipe that connects the pump actuating rod to the spray nozzle by causing it to run in a loop around the actuating rod. In this device, starting from the actuating rod, the flexible pipe is directed first of all towards the spray nozzle and then turns aside laterally thereafter. One disadvantage with this arrangement is that it requires available space for the passage of the flexible pipe between the actuating rod and the spray nozzle, something which is also incompatible with devices of a particular shape, particularly when the horizontal distance between the actuating rod and the spray nozzle is very short. Indeed, in such cases it is necessary to increase the curvature of the flexible pipe to a point where pressure drops may become unacceptable or there is a risk of causing the flexible pipe to kink.

U.S. Pat. No. 3,189,232 A envisages elevating the spray nozzle some distance from the valve rod in the vertical direction. This solution has the disadvantage of increasing the bulk of that part of the device that protrudes above the reservoir, and therefore forces a limitation on the capacity of said reservoir for a given overall bulk of the device.

It is an object of the invention to create a device that solves at least some of these disadvantages.

For that, the invention provides a device of the above type, characterized in that, starting from at least one of said ends, said connecting means have at least one end portion oriented in such a way as to diverge from a zone in the shape of a vertical flat band containing a geometric line directly connecting said actuating member and said outlet member.

In this configuration, the connecting means diverge, from one of their ends, or preferably from both, from a vertical band generated by the direct line between the actuating member, for example at the level of the outlet of the passage for the product, and the outlet member, for example at the level of its inlet for the product. This configuration makes it possible to increase the length of the connecting means, and in particular the length of their deformable portion(s), for example flexible portion(s). This increase in length results in the connecting means being routed outside of this vertical band, for example along at least one portion perpendicular to this vertical band, and this has the advantage of this lengthening not having a knock-on effect on the bulk of the device in the vertical direction.

The actuating member may consist of one or more element(s) which, together as appropriate, transmits or transmit a vertical actuating movement. The outlet member means one or more element(s) which imparts or impart an outlet direction to the stream of product ejected.

As a preference, said connecting means comprise a flexible tube. The connecting means may then comprise at least one male or female connector fixed to at least one of said actuating member and outlet member and able to be coupled in a sealed manner to said flexible tube, said connector being oriented in such a way as to form an angle with a geometric vertical plane containing said band, that is to say a vertical plane intersecting the outlet member and the actuating member. Thus, the desired orientation of the flexible tube is obtained without the risk of the latter becoming kinked.

Advantageously, said angle is greater than 30°, for example more or less equal to 90°.

The orientation of the end portions of the connecting means, for example of the end portions of a flexible tube, may be designed to route the connecting means through a particular sector of the horizontal plane, for example to route the connecting means in a way that suits a reservoir with a particular horizontal section.

As a preference, said connecting means, between said first and second ends, extend essentially on just one side with respect to said geometric vertical plane containing said band.

According to one particular embodiment of the invention, at least one of said end parts of the connecting means is oriented in such a way as to diverge from the opposite end of said connecting means. This then further lengthens the connecting means and this may be particularly useful when the distance in a straight line between the outlet member and the actuating member is very short.

According to another possible embodiment of the invention, said reservoir has an overall shape that is non-circular in horizontal section, for example an elliptical or oval shape, or alternatively a triangular, rectangular or trapezoidal shape.

As a preference in this case, said reservoir has, in horizontal section, a maximum dimension in a direction intersecting said geometric vertical plane containing said band-shaped zone, preferably more or less at right angles. This then yields a device that can easily be held in the palm of the hand.

Advantageously, a rigid cap is mounted on said reservoir in such a way as to enclose said actuating member and said connecting means between a wall of said cap and said wall of the reservoir supporting the ejection assembly, said actuating member comprising a moving push-button guided vertically through said wall of the cap.

As a preference, said push-button has a pressing surface accessible from the outside of said cap, said pressing surface being more or less aligned with an external surface of said cap when said push-button is in a rest position. This arrangement has an ergonomic advantage and reduces the risks of accidental actuating of the actuating member by comparison with a push-button that protrudes from the cap.

Advantageously, said actuating member comprises a hollow pump rod and a transmission rod attached between said push-button and said hollow pump rod, an intermediate wall being arranged between said rigid cap and said wall of the reservoir, said transmission rod being guided through said intermediate wall.

As a preference, said outlet member comprises a nozzle support fixed to said rigid cap and a spray nozzle fixed to said nozzle support.

The invention will be better understood and other objects, details, features and advantages thereof will become more clearly apparent in the course of the following description of some particular embodiments of the invention, given solely by way of nonlimiting illustration with reference to the attached drawing. In this drawing:

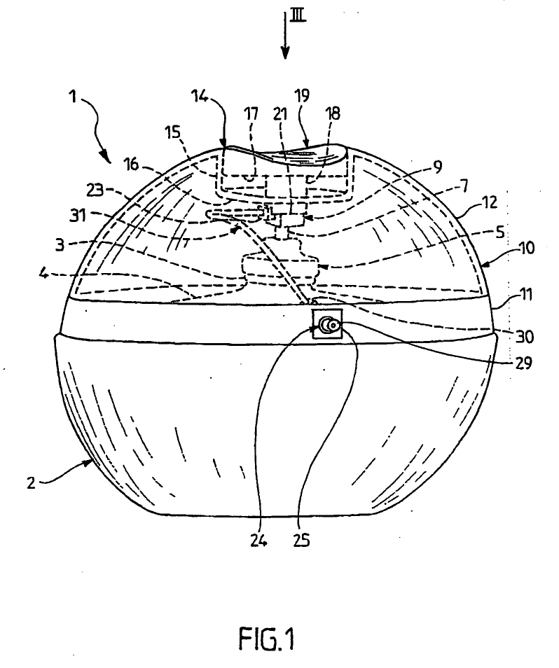

FIG. 1 is an overall perspective view of a device according to a first embodiment of the invention,

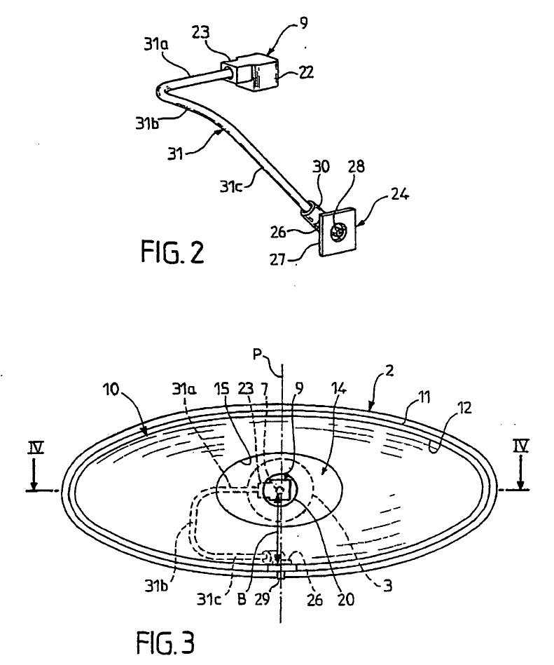

FIG. 2 is an enlarged perspective view of an end fitting, of a flexible tube and of a nozzle support of the device of FIG. 1,

FIG. 3 is a view from above of the device of FIG. 1,

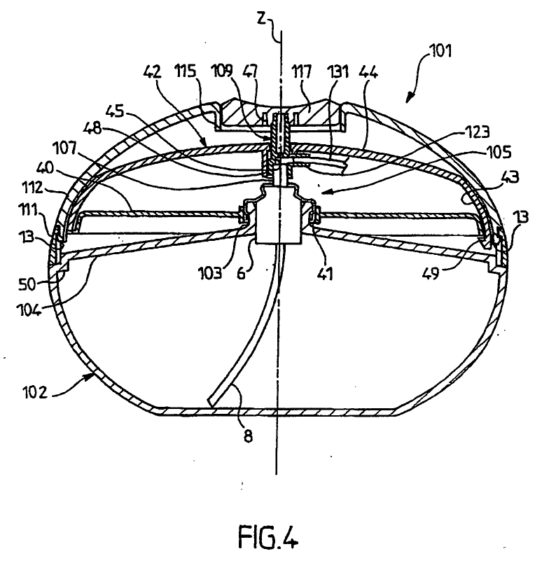

FIG. 4 is a view in section on the line IV-IV of FIG. 3 of a device according to a second embodiment of the invention.

With reference to FIGS. 1 to 3, a first embodiment of the device according to the invention is now described. This device is a portable atomizer, denoted overall by the numeral 1, intended for the packaging and dispensing of a liquid or semi-liquid product, for example a perfume.

The product is contained in a reservoir 2 of more or less elliptical horizontal section, as visible in FIG. 3. The reservoir 2 comprises a top wall 4 from the center of which a neck 3 protrudes. The reservoir 2 may be made of glass, for example.

A manually operated pump 5 is fixed by crimping onto the neck 3. The pump 5 is of a design known per se. It comprises a pump body 6, visible only in FIG. 4, housed in the neck 3 and defining a pumping chamber, and a hollow actuating rod 7 mounted such that it can slide in the pump body 6 to drive a pumping piston in the pumping chamber against the action of a return means (not depicted). By convention, the direction of travel of the hollow rod 7, depicted by the axis Z in FIG. 4, is termed the vertical direction.

The hollow rod 7 projects axially from the neck 3. It comprises an axial passage through which a quantity of product is ejected when the pump 5 is actuated, that is to say when the hollow rod 7 is pushed down into the pump body 6.

The reservoir 2 is surmounted by a rigid cap 10 made in two parts. A lower ring 11 is fixed by snap-fastening onto the reservoir 2, more or less at the periphery of the top wall 4. The lower ring 11 can be made of plastic such as ABS. Clipped onto the lower ring 11 is a transparent shell 12, which may be made of plastic such as PCTA. The clipping of the transparent shell 12 onto the lower ring 11 is performed by means of flexible hooks 13 formed as one with the shell 2, and depicted in FIG. 4, which catch on an interior rim of the ring 11. Thus assembled, the shell 12 and the ring 11 from the rigid cap 10 which has a more or less continuous exterior surface and an overall shape of a hollow semi-ellipsoid or of a cylinder of approximately hollow elliptical cross section, the lower edge of which hugs the contour of the top wall 4 of the reservoir 2.

At its top, the wall of the shell 12 forms a well 14 with a peripheral vertical wall 15 and an end wall 16. The well 14 contains a push-button 19 formed of a push-button head 17 which is guided in vertical sliding by the wall 15, and a push-button rod 18 which passes through the wall 16 through a central opening 20 formed therein. The push-button 19 is omitted from FIG. 3 in order to reveal the opening 20. The push-button head 17 has, in horizontal section, an approximately elliptical shape like the well 14, visible in FIG. 3.

The push-button 19 is arranged vertically in line with the hollow rod 7 of the pump 5 so that it can actuate it. For that, the push-button 19 is coupled to the hollow rod 7 by an end piece 9 which both transmits thrust from the push-button 19 and guides the product emerging through the hollow rod 7 towards connecting means which will be described later on. The push-button rod 18 has a lower end part 21 which is hollow to accept the end piece 9, the horizontal section of which is smaller than the section of the rod 18. The two elements are assembled by force-fitting or clipping-together.

In an alternative form of embodiment, the end piece 9 and the push-button 19 are molded as a single piece.

The end piece 9, best visible in FIG. 2, has a body 22 of cubic overall shape and a connecting sleeve 23 which extends from one of the lateral faces of the body 22. On its lower face, which is hidden in FIG. 2, the end piece body 22 has a cylindrical housing intended to accept the end of the hollow rod 7. This housing communicates via the inside of the end piece body 22 with the end wall of the sleeve 23 so as to allow the product expelled through the hollow rod 7 to pass as far as the sleeve 23. As visible in FIG. 1, the lower end part 21 of the push-button rod 18 has a tooth for the passage of the sleeve 23.

A square opening 25 is formed in the lower ring 11, at the middle of a long side of the ellipse, so as to attach a nozzle support 24. The nozzle support 24 comprises a short cylindrical body 26 and a square fixing flange 27 extending at right angles around the body 26 in the region of its front end. The fixing flange 27 is clipped into the opening 25. The body 26 contains an annular chamber of which the axial direction, more or less perpendicular to the wall of the ring 11, defines the outlet direction for the atomized product. At the center of the annular chamber, a peg 28 projects outwards from the nozzle support 24. A spray nozzle 29, not depicted in FIG. 2, is fixed to the peg 28 by clipping so as to atomize the jet of product. Fixed to the rear end of the body 26 is a connecting sleeve 30 which extends more or less at right angles to the axial direction of the body 26 and of the nozzle 29.

As an alternative, the opening 25 may be a circular hole allowing only the spray nozzle 29 to pass through, the nozzle support 24 then remaining hidden inside the lower ring 11.

A flexible tube 31 made of plastic, for example of TPX, connects the sleeve 23 and the sleeve 30 by being force-fitted in a sealed manner by its two respective ends into the two sleeves 23 and 30.

FIG. 3 uses the axis P to depict a geometric vertical plane which, when the atomizer 1 is in the assembled state, contains the direct line between the hollow rod 7 and the spray nozzle 29, that is to say that it intersects both the hollow rod 7 and the spray nozzle 29. The plane P is also a plane of symmetry of the reservoir 2 and the cap 10, which it intersects along the minor axis of the elliptical horizontal section. With respect to the plane P, both the sleeve 23 and the sleeve 30 are oriented in such a way as to diverge on the left-hand side in FIG. 3. In fact, the sleeve 23 is more or less perpendicular to the plane P, and therefore extends horizontally parallel to the major axis of the elliptical shape of the reservoir 2. The direction of the sleeve 30 forms an angle of about 45° with the plane P and also about 45° upwards with respect to a horizontal plane, that is to say a plane perpendicular to the hollow rod 7.

The flexible pipe 31 has, starting from the sleeve 23, a first end portion 31a which extends in the alignment of the axial direction of the sleeve 23, following the major axis of the elliptical shape of the reservoir 2, a central portion more or less perpendicular to the portion 31a, which extends horizontally and parallel to the minor axis of the elliptical shape of the reservoir 2, and a second end portion 31c which extends in alignment with the axial direction of the sleeve 30 and terminates at the end wall thereof.

The way in which the device 1 works will now be explained.

When the hollow rod 7 is in the position of rest, which is maintained for example by a return means internal to the pump 5, the upper pressing surface of the push-button head 17 is aligned with the adjacent wall of the shell 12, so that the cap 10 exhibits an even exterior surface. This position is depicted in FIG. 1. The pump 5 is actuated by manually depressing the push-button 19 vertically into the well 14. The total travel of the push-button is delimited by the position of abutment of the pump rod 7, so as to ensure that the pump is operated to full capacity, which ensures that a jet of product at high speed is obtained so that it can be atomized in the nozzle 29.

During the movement of the actuating member of the device, that is to say the push-button 19, the end piece 9 and the rod 7, towards the reservoir 2, the tube 31 deforms elastically in bending. Because of its very low stiffness, the tube 31 transmits no force or perceptible movement to the nozzle support 24. The product expelled through the hollow rod 7 passes through the internal canal of the end piece 9, the sleeve 23, the tube 31, the sleeve 30, the internal annular chamber of the body 26, and leaves via the spray nozzle 29.

The orientation of the sleeves 23 and 30 allows the tube 31 to be routed along a longer path, for example a path about two to four times longer, than a direct geometric line connecting the end of the hollow rod 7 and the inlet of the body 26 of the nozzle support 24. A straight tube directly connecting the hollow rod 7 and the nozzle support 24 would not be long enough to correctly absorb the movement of the actuating member. In fact, starting from the sleeve 23, the end portion 31a moves away from the nozzle support 24 to run in the direction of the horizontal plane in which the reservoir 2 has its maximum dimension, namely the direction of the major axis of the elliptical shape of the reservoir 2.

As an alternative, the sleeves 23 and 30 could of course be replaced with male connectors. The orientation of the sleeves 23 and 30 depicted in the figures is purely illustrative. For example, the sleeve 23 could go obliquely downwards instead of being horizontal and could diverge from the plane P, when viewed from above, at an angle other than 90°. For example, the sleeve 23 could, in a view from above, make an angle of between 30 and 90° with respect to the direction of the nozzle support 24, in order to lengthen the tube 31 to a lesser extent, or could form an angle of between 12° and 180° with respect to the direction of the nozzle support 24, in order to lengthen the tube 31 further.

In the configuration at 180°, the sleeve 23 would be oriented in the plane P, but still away from the vertical flat band B of the plane P which is generated by the direct line connecting the hollow rod 7 to the spray nozzle 29. As visible in FIG. 3, in the embodiment depicted, the band B is more or less delimited by the vertical axis of the hollow rod 7 and a vertical axis intersecting the nozzle support 24 or the spray nozzle 29.

Likewise, the orientation of the sleeve 30 could be altered, both in terms of its inclination with respect to the horizontal plane and with respect to the direction of the minor axis of the ellipse when viewed from above. Furthermore, the sleeve 30 can also be oriented vertically.

A second embodiment of atomizer, denoted overall by the numeral 101, is described with reference to FIG. 4. The elements which are identical or similar to those of the first embodiment are denoted by the same reference numerals as in FIGS. 1 to 3, increased by 100, and are not described again.

In the second embodiment, the lower ring 111 is formed as one piece with the baseplate 40 which has a central opening 41 to accept the neck 103 of the reservoir 102. The baseplate 40 covers the top wall 104 of the reservoir 102 when the atomizer 101 is in the assembled state.

Arranged between the baseplate 40 and the protective shell 112 is an upper ring 42 which has the overall shape of an approximately ellipsoidal shell of a smaller size than the shell 112. The upper ring 42 comprises a peripheral rim 43 the shape and curvature of which more or less correspond to those of the interior surface of the shell 112 and a central wall 44 which connects via its periphery to the rim 43, making an obtuse angle. The central wall 44 therefore runs horizontally overall at an intermediate level between the shell 112 and the baseplate 40.

The end piece 9 of the first embodiment is replaced by an end piece 109 which includes a thrust transmission rod guided through a central opening formed in the central wall 44 of the upper ring 42. In FIG. 4, the internal structure of the end piece 109 is visible: this consists of a two-stage cylindrical bore, a larger-diameter stage which accepts the hollow rod 107 as a close fit, a shoulder against which the end of the hollow rod 107 abuts, and a smaller-diameter stage, closed by an end wall, which forms a chamber 45 facing the end opening of the hollow rod 107 to receive the ejected product. The sleeve 123 extends at right angles to the lower bore of the end piece 109 and the inside of the sleeve 123 communicates with the chamber 45.

In the second embodiment, the well in the top of the shell 112 has no end wall. The peripheral vertical wall 115 has a free edge projecting towards the inside of the shell 112. The push-button head 117 is an attached component in the shape of an approximately elliptical plateau provided with a central sleeve 47 projecting from its underside to accept the upper end of the end piece 109. Two ribs (not depicted) able to elastically and radially grip the end of the end piece 109 are provided inside the sleeve 47 so as to hold the assembly together by clip fastening.

FIG. 4 also shows a dip tube 8 of the pump dipping down to the bottom of the reservoir 2 to suck the product up towards the pump body 6.

The tube 131 is arranged in a similar way to the first embodiment and the way in which the atomizer 101 works is identical to that of the atomizer 1.

The atomizer 101 is assembled in the following order: the tube 131 is assembled with, respectively, the nozzle support, not depicted in FIG. 4, and the sleeve 123. Next, the nozzle support is fixed to the lower ring 111 by clipping the sleeve of the nozzle support into the baseplate 40. The end piece 109 is engaged via its upper end at right angles through the central wall 44 of the upper ring 42, from the concave side thereof. A cylindrical guide wall 48 projects downwards around the central opening of the wall 44 to guide the end piece 109 in its functional movement intended to allow the pump to be actuated. The cylindrical wall 48 is equipped with an axial groove for the passage of the sleeve 123, to the right in FIG. 4, and, at the base of the groove, has two teeth (not depicted) projecting towards the inside of the groove. These teeth part elastically as the sleeve 123 is inserted and thereafter prevent the end piece 109 from disengaging from the upper ring 42. The upper ring 42 is then assembled onto the baseplate 40 by means of elastic clip-fastening tabs 49 which project vertically from the edge of the upper ring 42 in the continuation of the rim 43. The tabs 49 engage in corresponding cut-outs in the baseplate 40 and catch on the baseplate 40. During this assembly, the tube 131 housed inside the upper ring 42 is given the desired orientation, for example making it effect three quarters of a turn around the pump 105.

This design is advantageous in that the actuating and dispensing assembly formed by the plate 40, the upper ring 42, the nozzle support 24, the tube 131 and the end piece 109 may be preassembled independently of the reservoir 102, that is to say for example in a separate workshop. Similarly, the reservoir 102 can be filled and equipped with the pump 105 independently of the preassembled actuating and dispensing assembly. The remaining assembly operations are limited and simplified.

The baseplate 40 is then assembled with the reservoir 102 by fitting it onto the neck 103. At the same time, the pump rod 107 is engaged in the end piece 109. Inside the opening 41, the plate 40 has clip-fastening teeth (not depicted) which provide a firm attachment to the neck 103. In the assembled state, the lower ring 111 presses against a peripheral rim 50 of the reservoir 102. Thereafter, the push-button head 117 is mounted on the end piece 109. Pressure is repeatedly exerted on the push-button head 117 and this both allows a firm assembly of the end piece 109 with the hollow rod 107 and the push-button head 117, and primes the pump 105. Finally, the shell or cover 112 is assembled on the baseplate 40 and the ring 111 while at the same time engaging the push-button head 117 in the well at the top of the shell 112.

In the embodiments described, the actuating member for actuating the pump 5 or 105 comprises several elements in addition to the hollow pump rod 7 or 107, because the usual pumps are equipped with a fairly short piston rod. However, the piston rod of the pump could obviously be designed differently, for example with a greater length and forming a structure similar to the end piece 109, and the actuating member could then comprise more or fewer elements. Thus, by adapting the assembly operations described hereinabove, the push-button head 117 and the end piece 109 could also be molded as a single piece.

The outlet member may be placed at any point on the device, that is to say in particular above or below or at the same level as the pump rod in the vertical direction, and at any location around the peripheral direction of the reservoir.

The pump may also be replaced by a dispensing valve for a pressurized reservoir.

Although the invention has been described in conjunction with several particular embodiments, it is quite obviously not in any way limited thereto and comprises all technical equivalents of the means described and combinations thereof where these fall within the scope of the invention.

1-12. (canceled)

13. A packaging and dispensing device (1, 101) for a liquid or semi-liquid product, comprising a reservoir (2, 102), an ejection assembly (5, 105) supported on a wall (4, 104) of said reservoir and equipped with an actuating member (7, 9, 19; 107, 109, 117) emerging from said reservoir, said actuating member being able to be moved in an actuating direction (Z), known as the vertical direction, to eject a quantity of said product from said reservoir through a passage (45) formed in said actuating member, connecting means (23, 31, 30; 123, 131) which have a first end (23) connected to said actuating member and a second end (30) connected to an outlet member (24, 29) and which are deformable over at least part of their length (31) between said first and second ends so as to be able to conduct said quantity of product as far as said outlet member without transmitting substantial force to said outlet member, said outlet member being connected fixedly to said reservoir and comprising an outlet opening so as to be able to dispense said quantity of product, characterized in that, starting from at least one of said ends, said connecting means have at least one end portion (23, 30, 31a, 31c) starting from said one at least one end and oriented in such a way as to diverge from a zone (B) in the shape of a vertical flat band containing a geometric line directly connecting said actuating member (7, 9, 19; 107, 109, 117) and said outlet member (24, 29).

14. The device as claimed in claim 13, characterized in that said connecting means comprise a flexible tube (31, 131).

15. The device as claimed in claim 14, characterized in that said connecting means comprise at least one male or female connector (23, 30) fixed to at least one of said actuating member (7, 107) and outlet member (24) and able to be coupled in a sealed manner to said flexible tube, said connector being oriented in such a way as to form an angle with a geometric vertical plane (P) containing said zone.

16. The device as claimed in claim 15, characterized in that said angle is greater than 30°, for example more or less equal to 90°.

17. The device as claimed in claim 13, characterized in that said connecting means, between said first and second ends, extend essentially on just one side with respect to a geometric vertical plane (P) containing said zone (B).

18. The device as claimed in claim 13, characterized in that at least one (23) of said end parts of the connecting means is oriented in such a way as to diverge from the opposite end (30) of said connecting means.

19. The device as claimed in claim 13, characterized in that said reservoir (2, 102) has an overall shape that is non-circular in horizontal section.

20. The device as claimed in claim 19, characterized in that said reservoir has, in horizontal section, a maximum dimension in a direction intersecting a geometric vertical plane (P) containing said zone (B), preferably more or less at right angles.

21. The device as claimed in claims 13, characterized in that it comprises a rigid cap (10, 11, 12; 111, 112) mounted on said reservoir in such a way as to enclose said actuating member and said connecting means between a wall (12, 112) of said cap and said wall (4, 104) of the reservoir supporting the ejection assembly (5, 105), said actuating member (7, 107) comprising a moving push-button (17, 117) guided vertically through said wall of the cap.

22. The device as claimed in claim 21, characterized in that said push-button (17, 117) has a pressing surface accessible from the outside of said cap, said pressing surface being more or less aligned with an external surface (12, 112) of said cap when said push-button is in a rest position.

23. The device as claimed in claim 21, characterized in that said actuating member comprises a hollow pump rod (107) and a transmission rod (109) attached between said push-button (117) and said hollow pump rod, an intermediate wall (44) being arranged between said rigid cap (112) and said wall of the reservoir (104), said transmission rod (109) being guided through said intermediate wall.

24. The device as claimed in claim 21, characterized in that said outlet member comprises a nozzle support (24) fixed to said rigid cap (11, 111) and a spray nozzle (29) fixed to said nozzle support.
